(19) United States
(12) Patent Application Publication
(10) Pub. No.: US 2025/0157699 A1
(43) Pub. Date: May 15, 2025

(54) COMBINED FIXTURE FOR AUTOMATIC PRODUCTION OF MICRO COAXIAL CABLE HARNESS

(71) Applicant: Shaoguan University, Shaoguan (CN)

(72) Inventors: Jin LI, Shaoguan (CN); Lei YE, Shaoguan (CN); Zhipeng GUO, Shaoguan (CN); Zhihao LAI, Shaoguan (CN); Hui LONG, Shaoguan (CN)

(21) Appl. No.: 18/942,511

(22) Filed: Nov. 9, 2024

(30) Foreign Application Priority Data
Nov. 10, 2023 (CN) 202311495778.X

(51) Int. Cl. H01B 13/012; B23K 1/00; B23K 103/12; H02G 1/12

(52) U.S. Cl. CPC H01B 13/01245; B23K 1/0008; H01B 13/01209; H02G 1/128; B23K 2103/12

(57) ABSTRACT

A combined fixture for automatic production of a micro coaxial cable harness is provided, including a fixing mold arranged on a workbench, a fixing assembly positioned and arranged on the fixing mold and a positioning and cutting assembly. The fixing assembly includes a first fixing piece and a second fixing piece arranged in up-and-down correspondence, and the first fixing piece is provided with multiple first cable harness grooves arranged side by side for fixing a coaxial cable harness. The positioning and cutting assembly includes two copper sheet welding pads symmetrically arranged on the fixing mold, the two copper sheet welding pads are respectively arranged on two sides of the fixing assembly, and each of the copper sheet welding pads is provided with second cable harness grooves corresponding to the first cable harness grooves.

### CROSS-REFERENCE TO RELATED APPLICATIONS

This application claims priority to Chinese Patent Application No.202311495778.X, filed on Nov. 10, 2023, the contents of which are hereby incorporated by reference.

### TECHNICAL FIELD

The present disclosure belongs to the technical field of micro coaxial cable harness production, and in particular to a combined fixture for automatic production of a micro coaxial cable harness.

### BACKGROUND

At present, the production processes of a micro coaxial cable harness mainly include: cable arrangement and stripping, copper sheet soldering, cutting of core cable and copper sheet, plug soldering, shell soldering, connection, shell cleaning, testing and packaging. Among them, cable arrangement and stripping, copper sheet soldering, cutting of core cable and copper sheet mainly rely on manual operation. The realization process is as follows: laying out the cables manually in the fixed cable groove and fixing the micro coaxial cables with transparent glue; manually transferring the micro coaxial cable harness and placing the micro coaxial cable harness at the laser stripping machine to strip the sheath, shielding layer and insulating layer; manually transferring the micro coaxial cable harness and placing the micro coaxial cable harness at the pulse hot press; manually placing the lower copper sheet, the micro coaxial cable harness and the upper copper sheet in the mold in turn, and completing the copper sheet soldering by using the pulse hot press; and manually transferring the micro coaxial cable harness and placing the micro coaxial cable harness at a cutting machine to complete cutting the core cables and copper sheet.

However, the fixing of the cable harness for the production of the micro coaxial cables mainly depends on the way of manually sticking transparent glue, and the soft cable harness is not conducive to automatic machine clamping, and the subsequent tearing off of the adhesive tape may damage the cable harness sheath. Cable harness transportation mainly depends on manual transportation. The cable core of the cable harness is exposed prematurely, so the cable core is easily bumped and bent in the subsequent process transfer. The existing process has low automation, high demand for skilled workers, high labor cost and low production efficiency.

Therefore, the present disclosure designs a combined fixture for automatic production of a micro coaxial cable harness to solve the above technical problems.

### SUMMARY

In order to solve the above technical problems, the present disclosure provides a combined fixture for automatic production of a micro coaxial cable harness.

In order to achieve the above objective, the present disclosure provides a combined fixture for automatic production of a micro coaxial cable harness, including:
a fixing mold arranged on a workbench;
a fixing assembly positioned and arranged on the fixing mold, wherein the fixing assembly comprises a first fixing piece and a second fixing piece arranged in up-and-down correspondence, and the first fixing piece is provided with multiple first cable harness grooves arranged side by side for fixing a coaxial cable harness; and
a positioning and cutting assembly comprising two copper sheet welding pads symmetrically arranged on the fixing mold, wherein the two copper sheet welding pads are respectively arranged on two sides of the fixing assembly, and each of the copper sheet welding pads is provided with second cable harness grooves corresponding to the first cable harness grooves.

In an embodiment, the fixing mold is provided with multiple groups of first positioning pins, and the multiple groups of the first positioning pins are respectively positioned and clamped with the first fixing piece and the copper sheet welding pads.

In an embodiment, side walls of the first fixing piece and the second fixing piece are respectively provided with claw grooves to facilitate grasping by a manipulator.

In an embodiment, each of the copper sheet welding pads is provided with two copper sheet cutting grooves symmetrically arranged, and the two copper sheet cutting grooves are arranged in a same direction as the second cable harness grooves, and the two copper sheet cutting grooves are located at two sides of the second cable harness grooves respectively.

In an embodiment, each of the copper sheet welding pads is provided with a copper sheet positioning groove and a cable harness cutting groove, and the copper sheet positioning groove and the cable harness cutting groove are perpendicular to a direction of the second cable harness grooves.

In an embodiment, the coaxial cable harness includes multiple micro cables arranged side by side, a fixing tape is stuck between the micro cables, and two ends of the micro cables are fixedly connected through conductive copper sheets respectively.

In an embodiment, each of the micro cables includes a cable core sequentially coated with an insulating layer, a shielding layer and a sheath. The fixing tape is stuck and fixed with the sheath, and the conductive copper sheets are fixedly connected with the cable core.

In an embodiment, each of the conductive copper sheets comprises a first copper sheet and a second copper sheet arranged in up-and-down correspondence, and the cable core is located between the first copper sheet and the second copper sheet.

In an embodiment, the first copper sheet comprises a connecting piece matched with the copper sheet positioning groove, the connecting piece is fixedly connected to the cable core, and each of two ends of the connecting piece is fixedly connected with a positioning piece.

In an embodiment, multiple limit bolts are arranged at four corners of the fixing mold, and the limit bolts are in threaded connection with the workbench.

Compared with the prior art, the present disclosure has the following advantages and technical effects. The combined fixture for the automatic production of the micro coaxial cable harness is mainly used for improving the production efficiency and reducing the manpower demand in the production process to meet the needs of automatic coaxial cable production lines. The fixing mold is fixed on the workbench, and the fixing mold is provided with the detachable first fixing piece and the detachable second fixing piece which are in up-and-down correspondence. The fixing mold is provided with the copper sheet welding pads, which adopt a modular design and combine with the manipulator to realize automatic production. The first cable harness grooves on the first fixing piece and the second cable harness grooves on the copper sheet welding pad are used to fix the coaxial cable harness, so as to fix the soft fine cables, provide protection for the fine cables and reduce the damage of the fine cables in the production process. The arrangement of the first fixing piece and the second fixing piece has good effect and high precision in fixing the coaxial cable harness, and effectively avoids the distortion of fine cables.

The present disclosure has the advantages of compact structure, simple and convenient use and high degree of automation, which effectively improves the production efficiency of the coaxial cable harness and the production qualification rate, reduces the labor demand of the coaxial cable harness production, and also reduces the human proficiency in the production process.

### BRIEF DESCRIPTION OF THE DRAWINGS

The accompanying drawings, which constitute a part of the present disclosure, are used to provide a further understanding of the present disclosure. The illustrative embodiments of the present disclosure and their descriptions are used to explain the present disclosure, and do not constitute an improper limitation of the present disclosure. In the attached drawings:

FIG. 1 is an axial view of a fixing mold according to the present disclosure.

FIG. 2 is an axial view of a fixing assembly according to the present disclosure.

FIG. 3 is an axial view of a copper sheet welding pad according to the present disclosure.

FIG. 4 is a schematic diagram of a placement step of a first fixing piece according to the present disclosure.

FIG. 5 is a schematic diagram of a placement step of micro cables according to the present disclosure.

FIG. 6 is a schematic diagram of a placement step of a second fixing piece according to the present disclosure.

FIG. 7 is a schematic diagram of a first lifting step of the fixing assembly according to the present disclosure.

FIG. 8 is a schematic diagram of a first lowering step of the fixing assembly according to the present disclosure.

FIG. 9 is a schematic diagram of a first stripping step of the micro cables according to the present disclosure.

FIG. 10 is a schematic diagram of a second lifting step of the fixing assembly according to the present disclosure.

FIG. 11 is a schematic diagram of a placement step of a first copper sheet according to the present disclosure.

FIG. 12 is a schematic diagram of a second lowering step of the fixing assembly according to the present disclosure.

FIG. 13 is a schematic diagram of a placement step of a second copper sheet according to the present disclosure.

FIG. 14 is a schematic diagram of a second stripping step of the micro cables according to the present disclosure.

FIG. 15 is a schematic diagram of a cutting step of conductive copper sheets according to the present disclosure.

FIG. 16 is a schematic structural diagram of a coaxial cable harness according to the present disclosure.

FIG. 17 is a schematic structural diagram of the micro cables according to the present disclosure.

FIG. 18 is a schematic diagram of the fixing mold arranged on a workbench according to the present disclosure.

FIG. 19 is a flowchart of a production process using a combined fixture for automatic production of a micro coaxial cable harness according to the present disclosure.

### DETAILED DESCRIPTION OF THE EMBODIMENTS

In the following, the technical solutions in the embodiments of the present disclosure will be clearly and completely described with reference to the attached drawings. Apparently, the described embodiments are only a part of the embodiments of the present disclosure, but not all the embodiments. Based on the embodiments in the present disclosure, all other embodiments obtained by one of ordinary skill in the art without creative effort belong to the protection scope of the present disclosure.

In order to make the above objects, features and advantages of the present disclosure more obvious and easier to understand, the present disclosure will be further described in detail with the attached drawings and specific embodiments.

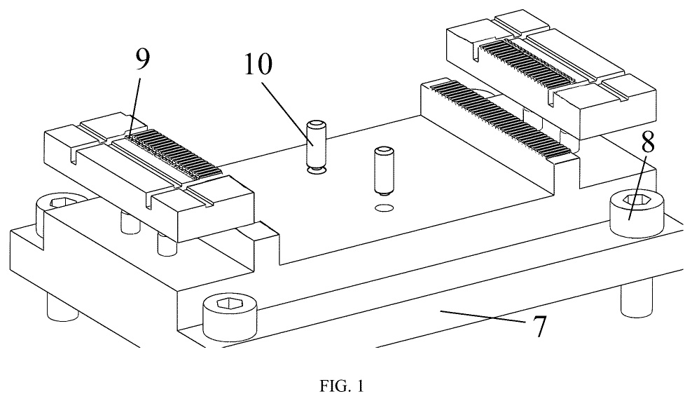

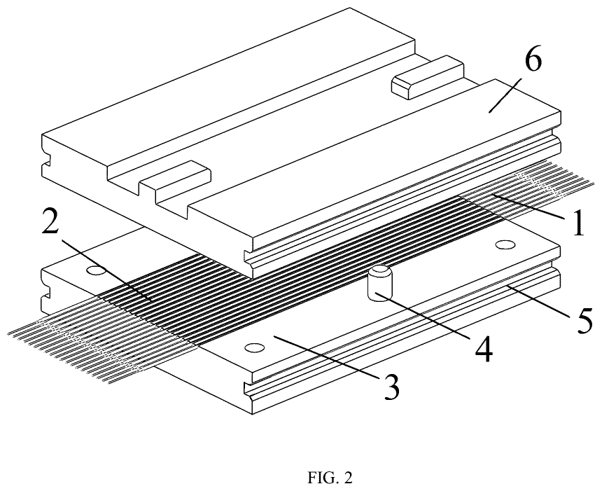

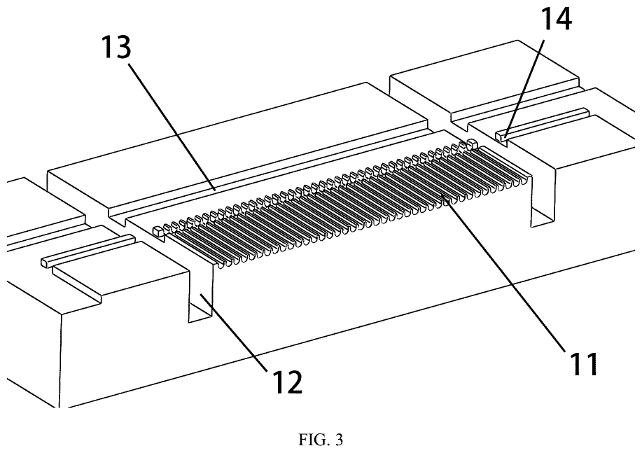

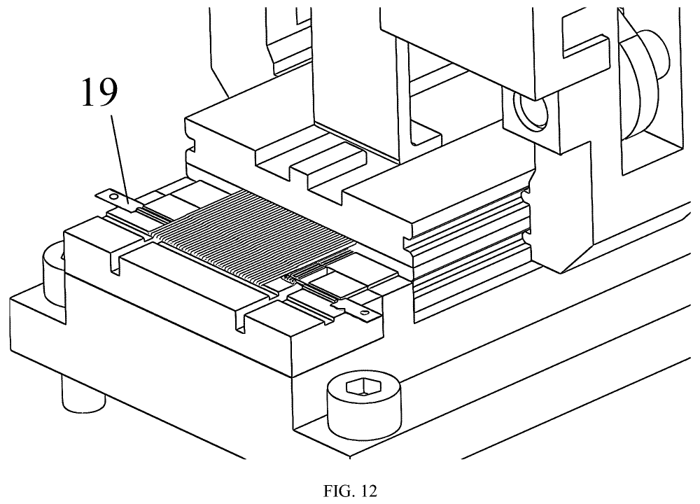

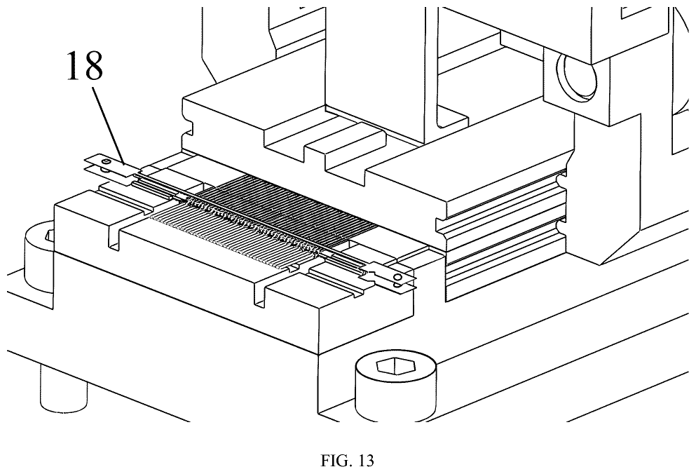

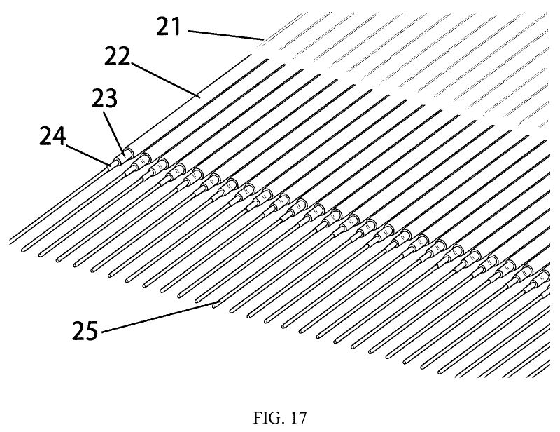

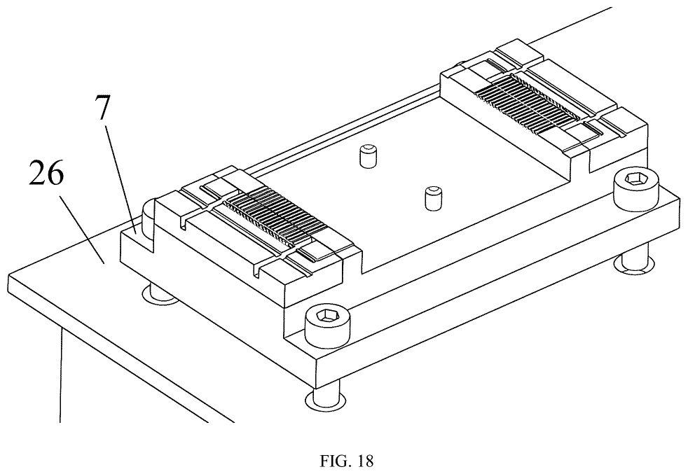

With reference to FIG. 1 to FIG. 18, this embodiment provides a combined fixture for automatic production of a micro coaxial cable harness, including a fixing mold 7, a fixing assembly and a positioning and cutting assembly. The fixing mold 7 is arranged on a workbench 26. The fixing assembly is positioned and arranged on the fixing mold 7. The fixing assembly includes a first fixing piece 3 and a second fixing piece 6. The first fixing piece 3 is arranged in up-and-down correspondence with the second fixing piece 6, and the first fixing piece 3 is provided with multiple first cable harness grooves 2 arranged side by side for fixing the coaxial cable harness 1. The positioning and cutting assembly includes two copper sheet welding pads 9 symmetrically arranged on the fixing mold 7, the two copper sheet welding pads 9 are respectively arranged on both sides of the fixing assembly, and each of the copper sheet welding pads 9 is provided with second cable harness grooves 11 corresponding to the first cable harness grooves 2.

The combined fixture for automatic production of the micro coaxial cable harness is mainly used for improving production efficiency and reducing manpower demand in the production process to meet the needs of automatic coaxial cable production lines. The fixing mold 7 is fixed on the workbench, and the fixing mold 7 is provided with the detachable first fixing piece 3 and the detachable second fixing piece 6 which are in up-and-down correspondence. The fixing mold 7 is provided with the copper sheet welding pads 9, which adopt a modular design and combine with a manipulator 15 to realize automatic production. The first cable harness grooves 2 on the first fixing piece 3 and the second cable harness grooves 11 on the copper sheet welding pad 9 are used to fix the coaxial cable harness 1, so as to fix the soft fine cables, provide protection for the fine cables and reduce the damage of the fine cables in the production process. The arrangement of the first fixing piece 3 and the second fixing piece 6 has good effect and high precision in fixing the coaxial cable harness 1, and effectively avoids the distortion of fine cables.

In an embodiment, the fixing mold 7 is provided with multiple groups of first positioning pins 10, the multiple groups of the first positioning pins 10 are respectively positioned and clamped with the first fixing piece 3 and the copper sheet welding pads 9. The first positioning pins 10 on the fixing mold 7 are used for positioning and fixing the first fixing piece 3 and the copper sheet welding pads 9, facilitating the automatic positioning and installation of the first fixing piece 3 and the copper sheet welding pads 9.

In an embodiment, the first fixing piece 3 is provided with second positioning pins 4 for positioning the second fixing piece 6, which is convenient for the manipulator 15 to automatically position and install the second fixing piece 6. When the micro coaxial cable harness is put into the first cable grooves, the first fixing piece 3 and the second fixing piece 6 complete the clamping and fixation of the cable harness by the second positioning pins 4.

In an embodiment, side walls of the first fixing piece 3 and the second fixing piece 6 are respectively provided with claw grooves 5 to facilitate grasping by the manipulator 15. The claw grooves 5 on the side walls of the first fixing piece 3 and the second fixing piece 6 are used for facilitating the grasping and positioning by the manipulator 15, preventing the fixing assembly from shaking during grasping, and improving the safety.

In an embodiment, each of the copper sheet welding pads 9 is provided with two copper sheet cutting grooves 12 symmetrically arranged, and the two copper sheet cutting grooves 12 are arranged in the same direction as the second cable harness grooves 11, and the two copper sheet cutting grooves 12 are located at two sides of the second cable harness grooves 11 respectively. The copper sheet cutting grooves 12 are located at two sides of the second cable harness grooves 11 respectively, which is convenient for equipment to cut conductive copper sheets and cut the conductive copper sheets into a predetermined shape.

In an embodiment, the copper sheet welding pad 9 is provided with a copper sheet positioning groove 14 and a cable harness cutting groove 13, and the copper sheet positioning groove 14 and the cable harness cutting groove 13 are perpendicular to the direction of the second cable harness grooves 11. The copper sheet positioning groove 14 is used for positioning and fixing the conductive copper sheets, so that the conductive copper sheets are positioned at designated positions of the micro cables 16, which is convenient for transformation and production. The cable harness cutting groove 13 is used for cutting the micro cables 16, so that the length of the coaxial cable harness 1 is standardized and the whole assembly line production is convenient.

In an embodiment, the coaxial cable harness 1 includes multiple micro cables 16 arranged side by side, and a fixing tape 21 is stuck between the micro cables 16, and two ends of the micro cables 16 are fixedly connected through conductive copper sheets respectively. The coaxial cable harness 1 includes the multiple micro cables 16 arranged side by side and fixed by a fixing tape 21. The spacing of the micro cables 16 is determined by the first cable harness grooves 2 and the second cable harness groove 11, and multiple micro cables 16 are fixedly communicated by the conductive copper sheets to form an integral cable harness.

In an embodiment, each of the micro cables 16 includes a cable core 25, the cable core 25 is sequentially coated with an insulating layer 24, a shielding layer 23 and a sheath 22, the fixing tape 21 is stuck and fixed with the sheath 22, and the conductive copper sheets are fixedly connected with the cable core 25.

In an embodiment, the conductive copper sheet includes a first copper sheet 17 and a second copper sheet 18, and the first copper sheet 17 is arranged in up-and-down correspondence with the second copper sheet 18. The cable core 25 is located between the first copper sheet 17 and the second copper sheet 18. The first copper sheet 17 and the second copper sheet 18 are limited and connected to the copper sheet welding pad 9, and the micro cables 16 are sandwiched between the first copper sheet 17 and the second copper sheet 18 to fix the micro cables 16.

In an embodiment, the first copper sheet 17 includes a connecting piece 20 matched with the copper sheet positioning groove 14, and the connecting piece 20 is fixedly connected to the cable core 25, and two ends of the connecting piece 20 are respectively fixedly connected with positioning pieces 19. The positioning piece 19 is provided with positioning holes and is fixed on each of the two sides of the connecting piece 20, and the connecting piece 20 is clamped in the copper sheet positioning groove 14, which is convenient for locating and fixing.

In an embodiment, the structure of the second copper sheets 18 is the same as the structure of the first copper sheets 17, so the details are not repeated here.

In an embodiment, multiple limit bolts 8 are arranged at the four corners of the fixing mold 7, and the limit bolts 8 are in threaded connection with the workbench. The limit bolts 8 are used to install the fixing mold 7 on the workbench, which is convenient for fixing and replacing.

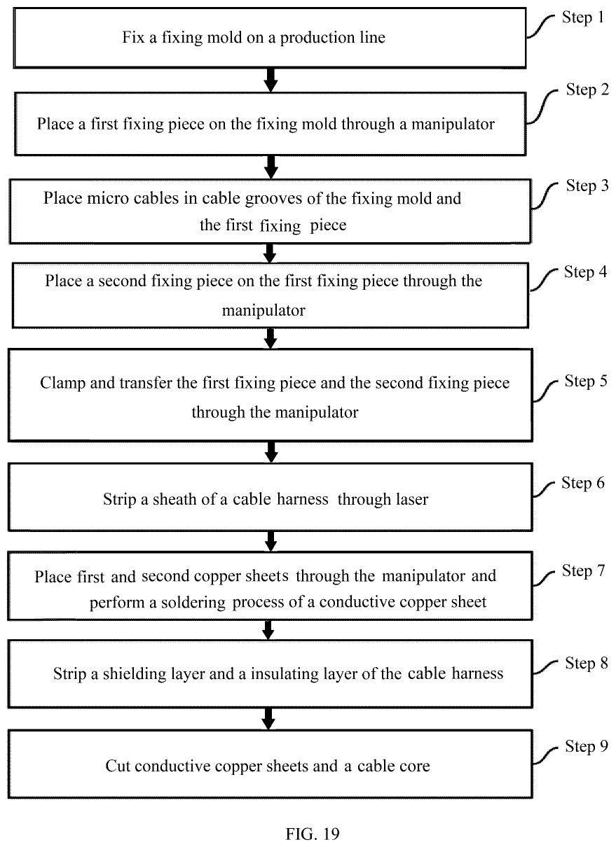

A production process using the combined fixture is provided, as shown in FIG. 19:

Step 1, the fixing mold 7 is fixed on a production line of the workbench.

The fixing mold 7 is fixed on a conveying mechanism by positioning bolts, and moves with the conveyor belt wheel, and the first fixing piece 3 is placed on the fixing mold 7. Each of the copper sheet welding pads 9 on the fixing mold 7 is provided with the second cable harness grooves 11, and the second cable harness grooves 11 coaxially corresponds to the first cable harness grooves 2 on the first fixing piece 3. The copper sheet cutting groove 12, the cable harness cutting groove 13 and the copper limiting groove are designed for fixing the cable harness, subsequent laser stripping of the cable harness, placing of conductive copper sheets, cutting of conductive copper sheets and cutting of the cable harness. The first positioning pins 10 on the fixing mold 7 are used for ensuring the accurate fixing of the copper sheet welding pads 9 and for the manipulator 15 to place the first fixing piece 3.

Step 2, the manipulator 15 places the first fixing piece 3 on the fixing mold 7.

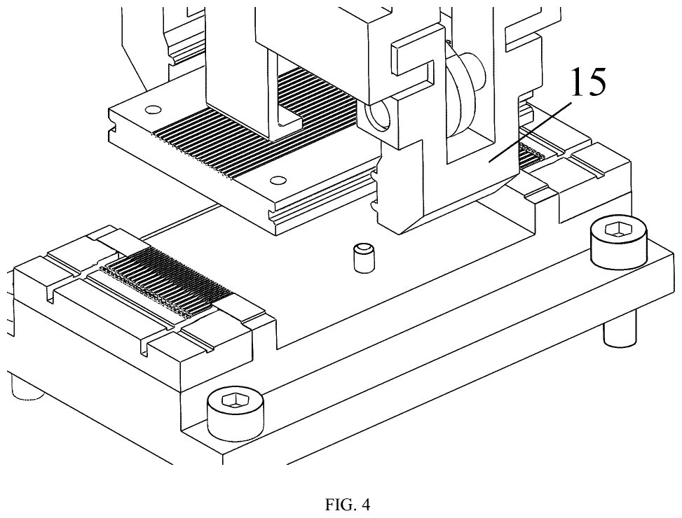

As shown in FIG. 4, the manipulator 15 grasps the claw grooves 5 of the first fixing piece 3, and accurately places the first fixing piece 3 on the fixing mold 7 according to the positioning of two pins on one side.

Step 3, the micro cables 16 are manually placed.

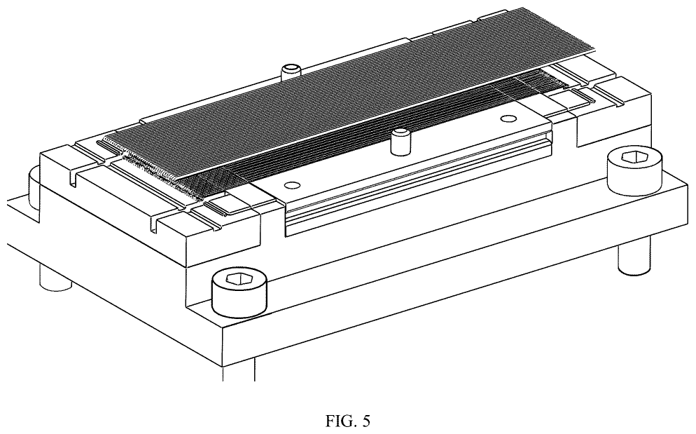

As shown in FIG. 5, the micro cables 16 with approximate lengths after rough cutting are placed in the cable grooves of the fixing mold 7 and the first fixing piece 3.

Step 4, the manipulator 15 places the second fixing piece 6 on the first fixing piece 3.

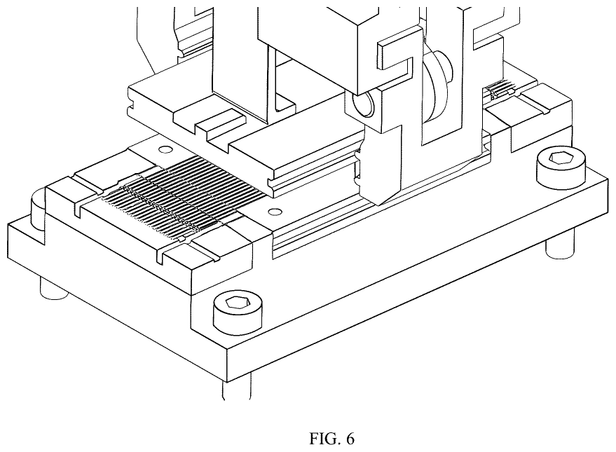

As shown in FIG. 6, the manipulator 15 clamps and places the second fixing piece 6 on the first fixing piece 3 to complete the clamping of the fixing assembly via the second positioning pins.

Step 5, the manipulator 15 clamps the first fixing piece 3 and the second fixing piece 6, and transfers to the other station.

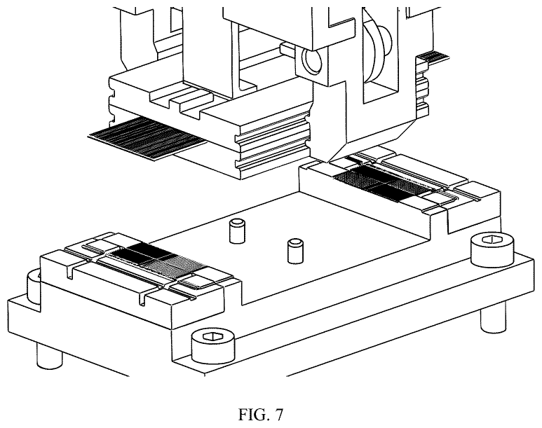

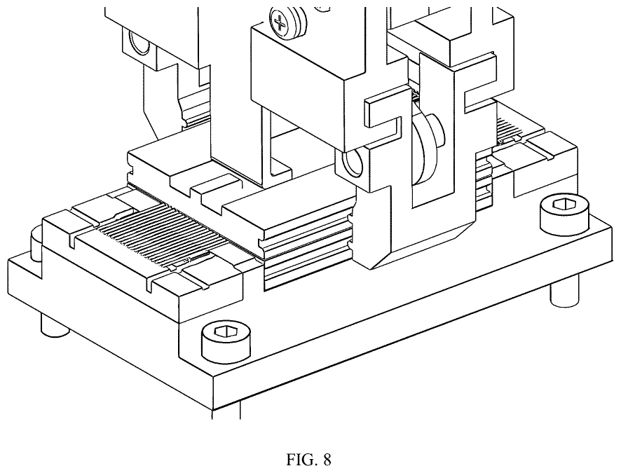

As shown in FIG. 7 to FIG. 8, after the cable harness is stably fixed by the first fixing piece 3 and the second fixing piece 6, the manipulator 15 lifts the fixing assembly and places the fixing assembly on the other fixing mold 7 at the subsequent station, and then the fixing mold 7 enters the laser wire stripping process through the conveyor belt.

Step 6, the sheath 22 of the cable harness is stripped by laser.

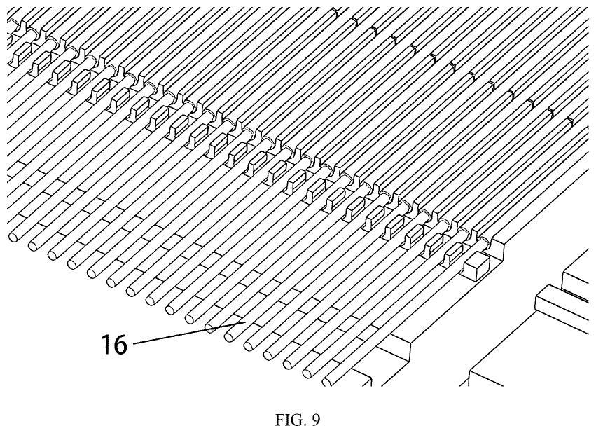

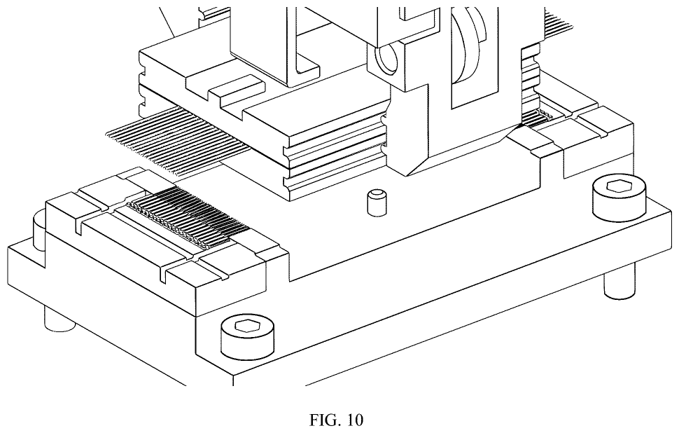

As shown in FIG. 9 to FIG. 10, after the cable harness enters the laser wire stripping process, the outermost sheath 22 of the micro coaxial cable harness is first stripped to obtain the coaxial cable harness 1 with the sheath 22 stripped, and then the manipulator 15 clamps the first fixing piece 3 and the second fixing piece 6 to the soldering process of the conductive copper sheets.

Step 7, the manipulator 15 lifts and lowers the fixing assembly.

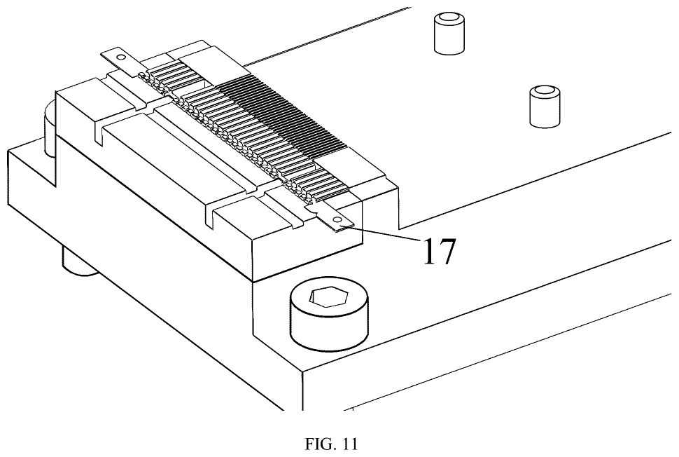

As shown in FIG. 11 to FIG. 13, the fixed first fixing piece 3 and second fixing piece 6 are clamped and lifted by the manipulator 15, and then the first copper sheets 17 are placed in cooperation with the manipulator 15, as shown in FIG. 11; then the manipulator 15 places the first fixing piece 3 and the second fixing piece 6; finally, the second copper sheets 18 are placed in cooperation with the manipulator 15. Under the action of pulse heater, the soldering process of conductive copper sheets is completed.

Step 8, the shielding layer 23 and the insulating layer 24 of the cable harness are stripped.

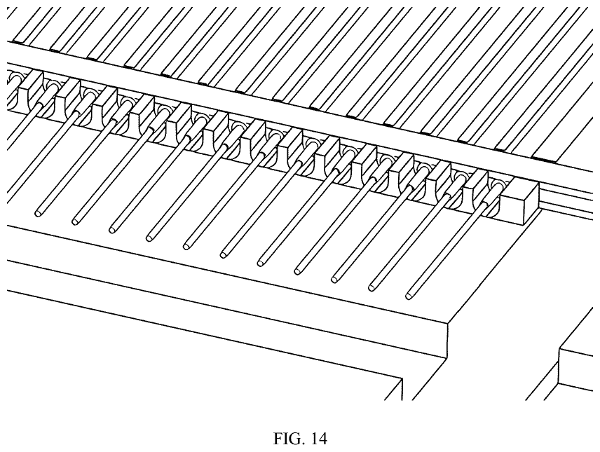

As shown in FIG. 14, after the soldering process of copper sheet is completed, the manipulator 15 clamps the first fixing piece 3 and the second fixing piece 6 again, and moves them to the laser stripping machine to strip the shielding layer 23 and the insulating layer 24 of the cable harness.

Step 9, the conductive copper sheets and the cable core 25 are sheared.

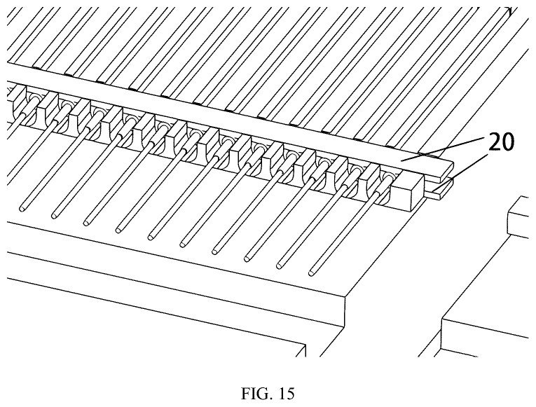

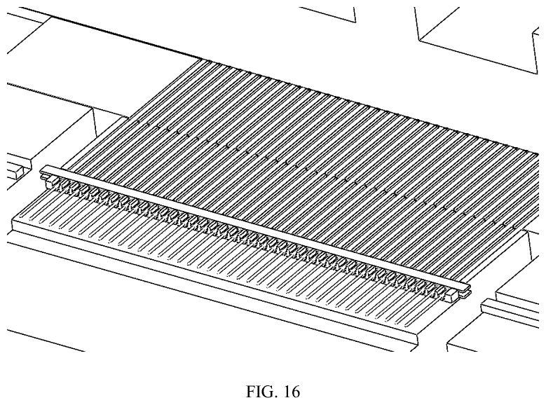

As shown in FIG. 15 to FIG. 16, after the shielding layer 23 and the insulating layer 24 of the cable harness are stripped by the laser stripping machine, the cutting jig cuts off the redundant conductive copper sheets after the fixing mold 7 enters the cutting equipment with the conveyor belt, and finally the cable core 25 is cut to obtain the cable harness with the required length.

In the description of the present disclosure, it should be understood that the terms “longitudinal”, “transverse”, “up”, “down”, “front”, “back”, “left”, “right”, “vertical”, “horizontal”, “top”, “bottom”, “inside”, “outside”, etc. indicate orientation or positional relationships based on the orientation or positional relationships shown in the accompanying drawings, only for the convenience of describing the present disclosure, and do not indicate or imply that the device or element referred to must have a specific orientation, be constructed and operated in a specific orientation, and therefore cannot be understood as a limitation of the present disclosure.

The above-mentioned embodiments only describe the preferred mode of the present disclosure, and do not limit the scope of the present disclosure. Under the premise of not departing from the design spirit of the present disclosure, various modifications and improvements made by one of ordinary skill in the art to the technical solution of the present disclosure should fall within the protection scope of the present disclosure.

What is claimed is:

1. A combined fixture for automatic production of a micro coaxial cable harness, comprising:
a fixing mold arranged on a workbench;
a fixing assembly positioned and arranged on the fixing mold, wherein the fixing assembly comprises a first fixing piece and a second fixing piece arranged in up-and-down correspondence, and the first fixing piece is provided with a plurality of first cable harness grooves arranged side by side for fixing a coaxial cable harness; and
a positioning and cutting assembly comprising two copper sheet welding pads symmetrically arranged on the fixing mold, wherein the two copper sheet welding pads are respectively arranged on two sides of the fixing assembly, and each of the copper sheet welding pads is provided with second cable harness grooves corresponding to the first cable harness grooves;
wherein the fixing mold is provided with a plurality of groups of first positioning pins, and the plurality of groups of the first positioning pins are respectively positioned and clamped with the first fixing piece and the copper sheet welding pads;
wherein side walls of the first fixing piece and the second fixing piece are respectively provided with claw grooves to facilitate grasping by a manipulator;
wherein each of the copper sheet welding pads is provided with two copper sheet cutting grooves symmetrically arranged, and the two copper sheet cutting grooves are arranged in a same direction as the second cable harness grooves, and the two copper sheet cutting grooves are located at two sides of the second cable harness grooves respectively;
wherein each of the copper sheet welding pads is provided with a copper sheet positioning groove and a cable harness cutting groove, and the copper sheet positioning groove and the cable harness cutting groove are perpendicular to a direction of the second cable harness grooves;
wherein the coaxial cable harness comprises a plurality of micro cables arranged side by side, a fixing tape is stuck between the micro cables, and two ends of the micro cables are fixed through conductive copper sheets respectively;
wherein each of the micro cables comprises a cable core sequentially coated with an insulating layer, a shielding layer and a sheath, wherein the fixing tape is stuck and fixed with the sheath, and the conductive copper sheets are fixedly connected with the cable core; and
wherein each of the conductive copper sheets comprises a first copper sheet and a second copper sheet arranged in up-and-down correspondence, and the cable core is located between the first copper sheet and the second copper sheet; and
further comprising: a production process using the combined fixture for the automatic production of the micro coaxial cable harness, wherein the process comprises following steps:
step 1, fixing the fixing mold on the workbench, wherein the first fixing piece is configured to be placed on the fixing mold, each of the copper sheet welding pads on the fixing mold is provided with the second cable harness grooves, and the second cable harness grooves coaxially correspond to the first cable harness grooves on the first fixing piece;
step 2, clamping the first fixing piece and accurately placing the first fixing piece on the fixing mold by the manipulator;
step 3, placing the micro cables with approximate lengths after rough cutting in the cable harness grooves of the fixing mold and the first fixing piece;
step 4, placing the second fixing piece on the first fixing piece by the manipulator to complete a clamping of the fixing assembly;
step 5, clamping the first fixing piece and the second fixing piece by the manipulator, transferring a station of the first fixing piece and the second fixing piece and placing the first fixing piece and the second fixing piece on another fixing mold at a subsequent station, and enabling the other fixing mold to enter a laser wire stripping process;
step 6, stripping the sheath of the cable harness by laser to obtain the coaxial cable harness with the sheath stripped, and transferring to a next process;
step 7, placing the first copper sheet and the second copper sheet through the manipulator, performing a soldering process of the conductive copper sheets;
step 8, stripping the shielding layer and the insulating layer of the cable harness after the soldering process is completed; and
step 9, cutting off redundant conductive copper sheets, and cutting the cable core to obtain the cable harness with a required length.

2. The combined fixture according to claim 1, wherein the first copper sheet comprises a connecting piece matched with the copper sheet positioning groove, the connecting piece is fixedly connected to the cable core, and each of two ends of the connecting piece is fixedly connected with a positioning piece.

3. The combined fixture according to claim 1, wherein a plurality of limit bolts are arranged at four corners of the fixing mold, and the limit bolts are in threaded connection with the workbench.
